(19) United States
(12) Patent Application Publication
(10) Pub. No.: US 2004/0060070 A1
(43) Pub. Date: Mar. 25, 2004

(54) System for distributing videos synchronized with music, and method for distributing videos synchronized with music

(76) Inventor: Noriyasu Mizushima, Tokyo (JP)

Correspondence Address: Jonathan P. Osha, ROSENTHAL & OSHA L.L.P., Suite 2800, 1221 McKinney St., Houston, TX, 77010, US

(21) Appl. No.: 10/634,109

(22) Filed: Aug. 4, 2003

(30) Foreign Application Priority Data
Sep. 17, 2002 (JP) P. 2002-269338
Mar. 20, 2003 (JP) P. 2003-077942

(51) Int. Cl. H04N 7/173

(52) U.S. Cl. 725/110; 725/112; 725/113

(57) ABSTRACT

A highly-elaborate video previously prepared so as to become tuned with predetermined music is stored as information in a server. Information pertaining to the synchronized video is distributed to a terminal from the server. Information about the synchronized video received by the terminal and information about songs of an inserted CD are transmitted to a display screen device and a performance device such that both information items are started at the same start time. The information items are displayed and performed, thereby attempting to achieve synchronization. In relation to activities of an artist, an advertisement of an enterprise, and information of a local public body, a video, sound, and music, which are desired to be distributed, are stored in advance in a server as information and distributed in the same manner. Information about synchronized videos can be deleted or added one after another.

### BACKGROUND OF THE INVENTION

1. Field of the Invention

The invention relates to a system for distributing videos synchronized with a CD purchased by a user, as well as to a method for distributing videos synchronized with a CD purchased by a user.

2. Description of the Related Art

Rhythmical music is played in a hall of a club or disco club, and videos synchronized with a song often appear on a screen installed in such hall. In the club or the disco club, a disc jockey, also called a DJ, is chiefly in charge of music to be played within the hall, and a visual jockey, also called a VJ (or a “video jockey”), is chiefly in charge of videos. The DJ audibly exhilarates the audience at the club or disco club by synthesizing music. The VJ also visually incites the audience of the club or disco club, by means of synthesizing video materials—which have various contents and a duration of several seconds each—various graphics, characters, and background colors of, thereby making it easy for the audience to dance in the hall or to put on-lookers in a good mood. Videos synchronized with music are instantaneously changed from one video to another in synchronism with music whose rhythm changes momentarily. Videos which arouse the audience's emotions and make the audience feel refreshed are also adopted by a game by means of which a player presses buttons or steps on predetermined locations in tune with music. Persons who purchase CDs are interested in information about the looks, clothes, and activities of artists, such as singers, as well as in their music. Many artists, such as singers, release promotional videos simultaneously with releasing music. Further, the artists offer information about their activities on TV programs, magazines, or home pages through the Internet. Enterprises which employ artists, such as singers, or their music as advertising means take great interest in how many of the public see an advertisement in association with artists, such as singers, and music.

Conventionally, even when a person visits a club or disco club, listens to music suiting his/her favorites, and views videos suiting his/her tastes, the person encounters difficulty in purchasing a favorite CD and acquiring videos which are synchronized with the song of the CD, are synthesized from various video materials, and momentarily change a screen. Many of the videos are not commercially available. Even when a person attempts to create videos, music rhythmically changes from one musical selection to another, and video materials must be acquired, thus involving consumption of much time. Many cases require artistic sensibilities. For instance, when the VJ attempts to create videos used in a club or a disco club; for example, when three video materials are superimposed one on another on a display screen, video materials to be stacked are positioned, in order from below, as a bottom material, a front material, and a top material. Video materials are changed in synchronism with a musical rhythm, as required. At that time, a determination must be rendered as to how an upper video material is stacked on a lower video material between the bottom and the front or between the front and the top and as to the effect of ink such as a color tone. Various display methods are available with regard to the effect of ink; for example, a method for rendering transparent white portions of an overlap existing between video materials, a method for inverting colors of video materials when the materials overlap each other, and a method for adding colors to a lower video material when video materials overlap each other, thereby rendering the colors of an upper video material into color circles. Moreover, in many situations, bottom and front video materials are rotated horizontally and vertically in synchronism with the rhythm of music; a display time of video material is sharply shortened or elongated; a display range of video material is narrowed to half or one-third a display screen; the position of video material is changed within the display screen; and letters are superimposed on video material and the letters are subjected to rotation or a change in color. In addition, there are employed effects, such as addition of vertical and horizontal stripes to video material, momentary addition of mosaics to video material, or addition of a pattern such as a ripple on a water surface to the entire screen. As described above, difficulty is encountered when an ordinary person attempts to create such videos as those which are created by a VJ in a club or a disco club and synchronized with the rhythm of music.

A person can view videos synchronized with music in the form of a broadcast of musical TV programs, a promotion video, and a video CD, by way of a TV set, a video, and a personal computer. However, videos broadcast on a TV show consist of scenes showing that an artist, such as a singer, is singing on a stage set and are intended for the general public. Many such videos are based on images such as promotion videos. Information about videos of a promotion video or those of a video CD is fixed on mediums such as video tapes. Viewing a new video synchronized with music on the basis of only this information has been impossible. As mentioned above, even when the user has purchased a CD suiting his/her tastes, the user encounters difficulty in acquiring videos synchronized with the music that suits his/her tastes. A technique pertaining to Karaoke described in, JP-A-2000-200089, is described as a technique for synchronizing music and lines with a background image. For example, videos created by a VJ in a club or a disco club must be changed momentarily in strict synchronism with music which changes instantaneously. Further, as mentioned previously, various laborious operations are required. These videos differ in quality from videos whose Karaoke lines and background images change gently and whose background images have no elaborate contents. Many Karaoke distribution companies distribute music. Special information to be used for synchronizing music with videos is inserted into music. As in the case of a problem in a recent CD programmed so as to inhibit duplication of contents with a personal computer, when information about music is processed, exertion of adverse influence on music can be of concern. In light of a problem of copyright on videos and music, easy distribution of music is problematic. When downloaded music or videos are accumulated in a personal computer, there arises a copyright-related problem such as unauthorized transfer of music or videos. Information about activities of artists, such as singers, can be acquired from a TV program, a magazine, or a homepage on the Internet. When fans of an artist, such as a singer, readily attempt to acquire information about activities of the artist, the fans must view a specific TV program, purchase a specific magazine, or access a specific home page, thus suffering complications. In addition to an advertisement employing, as means, TV programs and articles of magazines involving emergence of artists such as singers, or artists such as singers and music appearing in TV programs and magazines, provision of an advertisement which is more readily and frequently exposed to the public eye is important for the enterprises that employ artists, such as singers, and music as advertising means.

In addition, in terms of enhancement of effects and education, important features are the ability to acquire videos showing playing of a symphony performed by a symphony orchestra, music pertaining to RAKUGO (Japanese Comic Stories) and KABUKI music, and videos pertaining to performance of a RAKUGO-KA (Japanese Professional Storyteller) and a KABUKI play in synchronism with sounds. In view of a copyright and the capacity of a CD, acquisition of music and videos synchronized with sound is difficult.

### SUMMARY OF THE INVENTION

Drawbacks to be solved by the invention are: the means by which user can view videos synchronized with the song of a purchased CD; whether or not synchronized videos can be changed as required; whether or not the user can select videos suiting his/her tastes; how efficiently an artist, such as a singer, informs fans of information about himself/herself; how efficiently an enterprise which provides an advertisement for an artist, such as a singer, as means provides an advertisement; and the means by which copyright of songs and videos can be protected.

As a result of considerable studies being carried out for solving the drawbacks, the following configuration is found to be optimal. A terminal used by the user is connected to a server by utilization of the Internet. If a CD inserted into the terminal is an extra CD, information pertaining to songs recorded on the CD is read. In contrast, if the inserted CD is not an extra CD, a CD ID is read, and information is transmitted to the server. The server stores music information about CD titles and song titles pertaining to songs released by various singers and artists; synchronized video information about videos prepared in synchronism with music list information and predetermined music; and synchronized video list information. In addition, the server stores relevant video information, relevant sound information, and relevant list information, as relevant information. Such relevant information includes, for example, artist video information about activities of an artist such as a singer; artist sound information about sound to be added to the artist video information; advertisement video information about advertisements of enterprises which provide advertisements; advertisement sound information pertaining to sound added to the advertisement video information; offered video information pertaining to information offered to other users by other organizations such as public organizations; offered sound information pertaining to sound to be added to the offered video information; artist list information pertaining to a list of accumulated information; advertisement list information; and offered list information. The server receives read information and input information and, on the basis of the received read information and input information, transmits, to the terminal, predetermined synchronized video information synchronized with music recorded on a CD. On the basis of the received input information, relevant image information, relevant sound information, and relevant list information are transmitted, as required. For instance, the artist video information and the artist sound information are transmitted to the terminal; the advertisement video information and the advertisement sound information are transmitted to the terminal; and the offered video information and the offered sound information are transmitted to the terminal. Upon receipt of the synchronized video information and the relevant video information, the terminal displays, on the screen, videos and lists based on the information items, thereby playing the music recorded on the CD. Consequently, the terminal displays, a video synchronized with music, video information about activities of an artist, and a video of an advertisement. Sound added to the videos is played or output.

### BRIEF DESCRIPTION OF THE DRAWINGS

FIG. 1 is a block diagram of a system;

FIG. 2 is an example list pertaining to music list information;

FIG. 3 is an example list pertaining to synchronized video list information;

FIG. 4 is an example list pertaining to artist list information;

FIG. 5 is an example list pertaining to advertisement list information;

FIG. 6 is an example list pertaining to offered list information;

FIG. 7 is a block diagram of a system B;

FIG. 8 is an example display screen device B; and

FIG. 9 is a block diagram of a system C.

### DESCRIPTION OF THE PREFERRED EMBODIMENTS

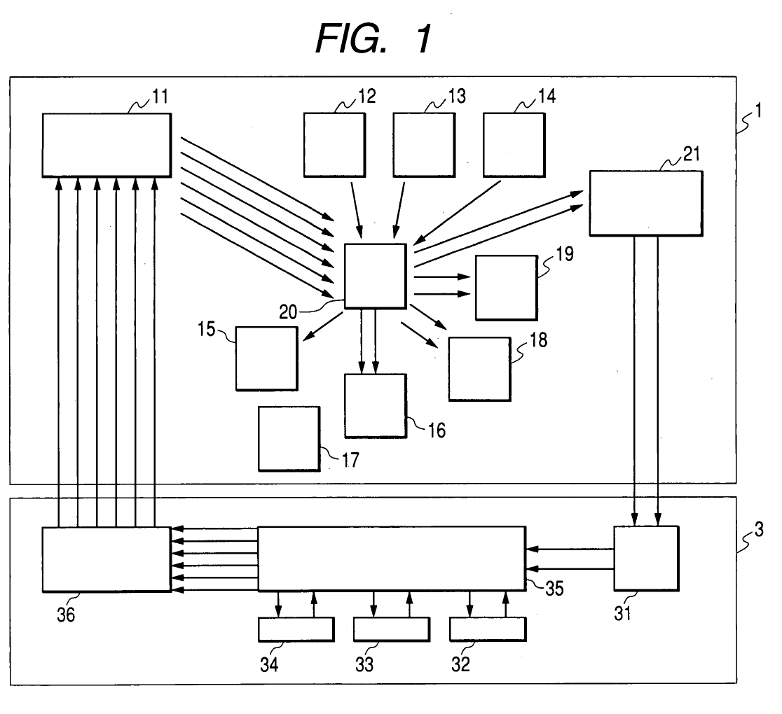

The invention will now be described in detail hereinbelow. First, an invention of claim 1 will be described. FIG. 1 is a system block diagram. A terminal 1 comprises a terminal receiver 11; a CD drive 12; a terminal input device 13; a music information reader 14; a music information screen device 15; a video information screen device 16; a changeover button device 17; a display screen device 18; a performance device 19; a synchronization analyzer 20; and a terminal transmitter 21. A server 3 comprises a server receiver 31; a music information storage device 32; a synchronized video information storage device 33; a relevant information storage device 34; an information analyzer 35; and a server transmitter 36.

The terminal 1 may be a personal computer or musical equipment capable of being connected to the Internet. One or a plurality of terminals 1 are connected to the server 3 over the Internet. In terms of the ability to transmit a large volume of synchronized video information, broadband communication capable of sending and receiving a large volume of information is preferable. The terminal receiver 11 is a device for receiving music list information, synchronized vide information, and synchronized video list information; for example, relevant video information, e.g., artist video information, advertisement video information, and offered video information; relevant sound information, e.g., artist sound information, advertisement sound information, and offered sound information; and relevant list information, e.g., artist list information, advertisement list information, and offered list information, all being sent by the server transmitter 36. The terminal receiver 11 does not store synchronized video information, and transmits received information to the synchronization analyzer 20.

The CD drive 12 is a so-called CD drive for reading information pertaining to music to be recorded on a CD and receives an inserted CD. A CD drive incorporated in a commercially-available personal computer or a CD drive incorporated into predetermined sound equipment may be used as the CD drive. The information read by the CD drive 12 is transmitted to the synchronization analyzer 20 as CD information. The terminal input device 13 enables a user to input information, such as a CD title, a song title, and the name of an artist, in letters and symbols; to select desired information from an at-a-glance list displayed by the music information screen device 15 and the video information screen device 16; and to input a selection result or click the changeover button device 17, thereby selecting information about, e.g., activities of an artist, or information about an advertisement of an enterprise, or information offered by public organizations, and inputting a selection result. The terminal input device 13 may be embodied by a keyboard and a mouse. Even when the music information screen device 15 displays the sound list information and the read information in the form of an at-a-glance list, the terminal input device 13 can delete them, to thereby enable input of a CD title, a song title, or the name of an artist in letters and symbols. Even when the video information screen device 16 displays the synchronized video list information and the relevant list information in the form of an at-a-glance list, the terminal input device 13 deletes them, to thereby enable input of the title of a video in letters and symbols. The terminal input device 13 sends the information entered by the user to the synchronization analyzer 20 as input information. When the CD inserted into the CD drive 12 is an extra CD, the sound information reader 14 reads the title of the extra CD, a song title, and the name of an artist from the extra CD. The information read by the sound information reader 14 is transmitted to the synchronization analyzer 20 as read information. When the CD inserted into the CD drive 12 is not an extra CD, the sound information reader 14 transmits, to the synchronization analyzer 20, read information indicating a failure to read the title of the CD, a song title, and the name of an artist.

The music information screen device 15 receives the music list information transmitted from the synchronization analyzer 20. On the basis of music list information, the music information screen device 15 displays, in the form of an at-a-glance list, for example, only a song title; three information items, i.e., a CD title, a song title, and the name of an artist; or an at-a-glance list providing, e.g., the same song titles or the same CD titles. The video information screen device 16 receives the synchronized video list information and the relevant list information sent from the synchronization analyzer 20. On the basis of the synchronized video list information, the video information screen device 16 displays an at-a-glance list which provides only the titles of videos or into which the titles of videos or the name of a video producer is categorized. On the basis of the relevant list information, e.g., artist list information, the video information screen device 16 displays only the name of an artist or information items pertaining to activities released by the artist, in the form of an at-a-glance list and in ascending chronological order. For instance, when based on an advertisement list information, the video information screen device 16 displays an at-a-glance list showing only names of enterprises which provide advertisements. When based on offered information, the video information screen device 16 displays an at-a-glance list of, e.g., information offered by public organizations.

When the user switches desired information, the changeover button device 17 is to be clicked by the user through use of the terminal input device 13. For instance, a synchronized video button, an artist information button, an advertisement information button, and an offered information button are provided. When the user has clicked a desired button, the terminal input device 13 transmits information serving as a result of clicking action to the synchronization analyzer 20 as input information. The display screen device 18 receives the synchronized video information and the relevant video information transmitted from the synchronization analyzer 20 and displays videos on the basis of the synchronized video information and the relevant video information. For instance, the videos include videos which are synchronized with music and have been prepared by a VJ in a club or a disco club; videos pertaining to recent activities of a singer or an artist; advertising videos of an enterprise; or videos offered by public organizations. The performance device 19 receives the CD information and the relevant sound information, both being transmitted from the synchronization analyzer 20. On the basis of the CD information, the performance device 19 plays the music recorded on the CD, thereby playing music and sound on the basis of the relevant sound information.

The synchronization analyzer 20 brings a video into synchronism with music and analyzes the kind of a video, music, and sound to be played and output. The synchronization analyzer 20 receives the music list information, synchronized video information, synchronized video list information, relevant video information, relevant sound information, and relevant list information, all being transmitted by the terminal receiver 11; the CD information transmitted from the CD drive 12; input information which is transmitted from the terminal input device 13 and includes a CD title, a song title, the name of an artist, and the title of a video, all being input by the user; a result obtained when the user has selected information from the at-a-glance list displayed by the music information screen device 15; input information obtained as a result of the user having clicked the changeover button device 17; and read information transmitted from the music information reader 14. The synchronization analyzer 20 transmits the received read information and the received input information to the terminal transmitter 21 and transmits the music list information to the music information screen device 15.

The synchronization analyzer 20 transmits the synchronized video list information and the relevant list information to the video information screen device 16. The synchronization analyzer 20 receives the input information which is obtained as a result of the user having selected information from the at-a-glance list displayed by the video information screen device 16, and transmits the thus-received information to the terminal device 21. The synchronization analyzer 20 also transmits the received synchronization video information to the display screen device 18, as well as transmitting the received CD information to the performance device 19, such that a time at which display of a video is started becomes synchronized with a time at which playing of music is started. Further, the synchronization analyzer 20 also transmits the received relevant video information to the display screen device 18, as well as transmitting the received relevant sound information to the performance device 19, such that a time at which displaying of a video is started is synchronized with a time at which performance and output of sound are started. As a result, the user can view and listen to a video and sound, both being synchronized with activities of an artist such as a singer, a video and sound synchronized with an advertisement of an enterprise, and a video and sound, both being synchronized with each other and offered by a public organization. According to the invention, a video and music or sound can be displayed and played synchronously. When the user stops playing of music or sound, the video is also stopped synchronously. The user can acquire a highly-elaborate video, music, and sound. However, the synchronized video information-which has been selected by an information analyzer 35 from the information, such as a title of a video and the name of tempo, input by the user through use of the terminal input device 13 in characters or symbols-is not prepared in synchronism with the music recorded on the CD. Hence, music is not in step with the video. In this case, the synchronization analyzer 20 may not transmit CD information to the performance device 19.

The terminal transmitter 21 transmits, to a server receiver 31, the read information and the input information transmitted by the synchronization analyzer 20. Music list information, synchronized video information, synchronized video list information, relevant video information, relevant sound information, and relevant list information may be transmitted to a server transmitter 36, thereby inhibiting the terminal 1 from storing information, such as synchronized video information. Consequently, the copyright on a video synchronized with music, that on a video pertaining to activities of an artist such as a singer, and that on voice can be protected.

A server receiver 31 receives the read information and input information transmitted by the terminal transmitter 21 and transmits the read information and the input information to the information analyzer 35. The music information storage device 32 stores music information and music list information and enables deletion and alteration of music information and music list information in the past, or addition of new music information. The music information relates to the music released in the past by an artist, such as a singer, and is given a designation such as a CD title, a song title, and the name of an artist. In addition, the music information may relate to, e.g., the tempo, length, or genre of music. The music information is associated with synchronized video information about a synchronized video which is prepared such that music information is brought into step with a song of a relevant CD. The music list information stored in the music information storage device 32 may be, e.g., music list information into which a plurality of CD titles, a plurality of song titles, and names of artists are arranged in the form of a list in the order of the Japanese KANA syllabary, or music list information into which currently popular numbers are arranged in the form of a list. The synchronized video information storage device 33 stores synchronized video information and enables deletion or alteration of synchronized video information of the past and addition of new synchronized video information. The synchronized video information is prepared such that associated music information becomes synchronous with the song of a relevant CD, by making a play start time of a song of the CD concurrent with a display start time of a synchronized video. Further, a large number of videos prepared by a VJ, such as those which can be seen in a club or a disco club, are stored, thereby providing the user with a highly-elaborate, high-quality video. Moreover, appropriate deletion or addition of video information enables provision of everlastingly-attractive videos to the user. For instance, a designation, such as the title of a video or the name of tempo, is added to synchronized video information. The synchronized video information includes a video synchronized with a song of a CD or a video synchronized with sound other than a song of a CD, such as Japanese ROKYOKU reciting or Japanese RAKUGO (comic stories).

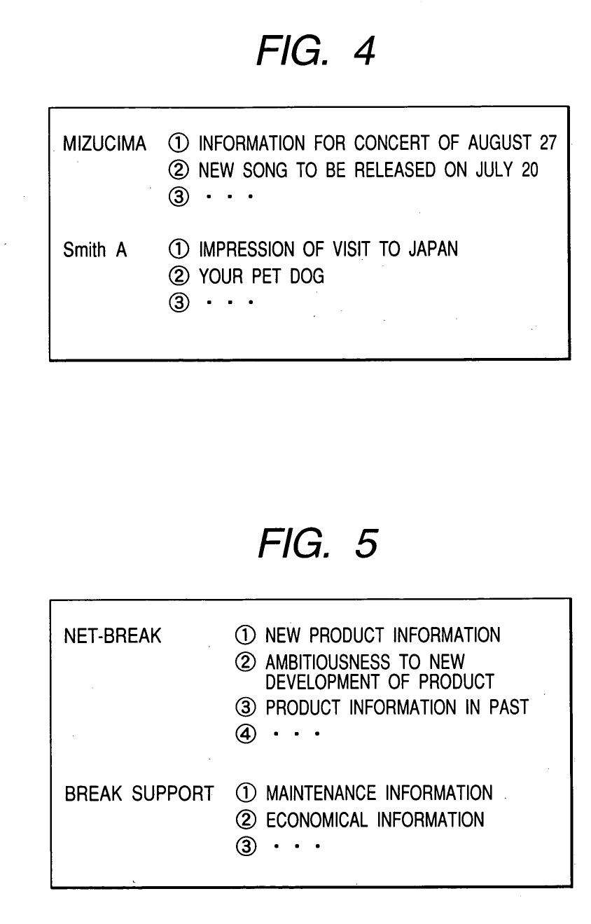

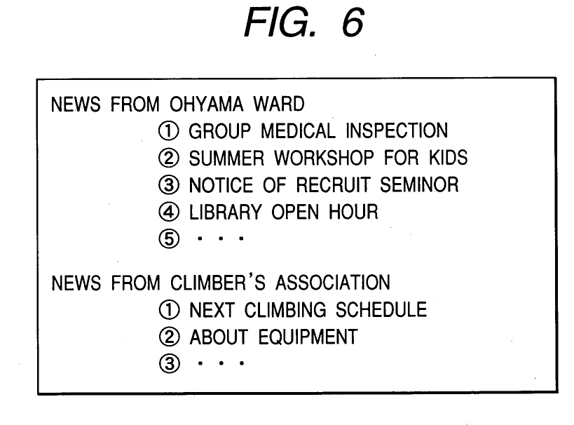

The relevant information storage device 34 stores relevant information and enables deletion or alteration of relevant information of the past and addition of new relevant information. The relevant information is formed from relevant video information, relevant sound information, and relevant list information, and respective relevant information pieces are assigned designations. FIG. 4 shows an example at-a-glance list pertaining to artist list information; FIG. 5 shows an example list pertaining to advertisement list information; and FIG. 6 shows an example list pertaining to offered list information. As mentioned above, such relevant information items include artist video information pertaining to activities of an artist, e.g., a singer; artist sound information pertaining to sound to be added to the artist video information; advertisement video information pertaining to advertisements of enterprises to be advertised; offered video information pertaining to information offered to other users by other organizations such as public organizations; offered sound information pertaining to sound to be added to the offered video information; artist list information pertaining to a list of stored information items; advertisement list information; and offered list information. The relevant information is not fixed to these categories. For instance, artist video information is described specifically. Information which an artist desires to report by himself/herself is taken as artist video information, and sound to be added to the video is synchronized with the video, to thereby prepare artist sound information. Artist list information is prepared, in which information is arranged in the sequence of information items released in the past or according to categories to which information pertains. The artist list information is stored in the relevant information storage device 34. For instance, the advertisement video information will be described specifically. Advertisement video information showing an artist, such as a singer, who is taken as advertising means by an enterprise is prepared. Advertisement sound information is prepared such that sound to be added to the video is synchronized with the video. Advertisement list information is prepared, in which information is arranged in the form of a list in the sequence of advertisements released in the past or according to products which are objects of the advertisements. The advertisement list information is stored in the relevant information storage device 34. For instance, the offered video information will now be described specifically. News and information which the public organization desires to report to the user are visualized, to thereby prepare offered video information. Offered sound information is prepared by bringing sound to be added to a video in synchronism with the video. Offered list information is prepared, in which information is arranged in the form of a list in the sequence of news and information of the past or according to categories of news and information. The offered list information is stored in the relevant information storage device 34. The respective relevant information items can be deleted or added appropriately, thereby enabling provision of everlastingly-attractive relevant information to the user. Only relevant video information can be offered without relevant sound information to be added to the relevant video information. Conversely, only relevant video information can be offered without relevant sound information. The relevant list information makes it easy for the user to select desired information from enormous amounts of information, thus providing the user with convenience.

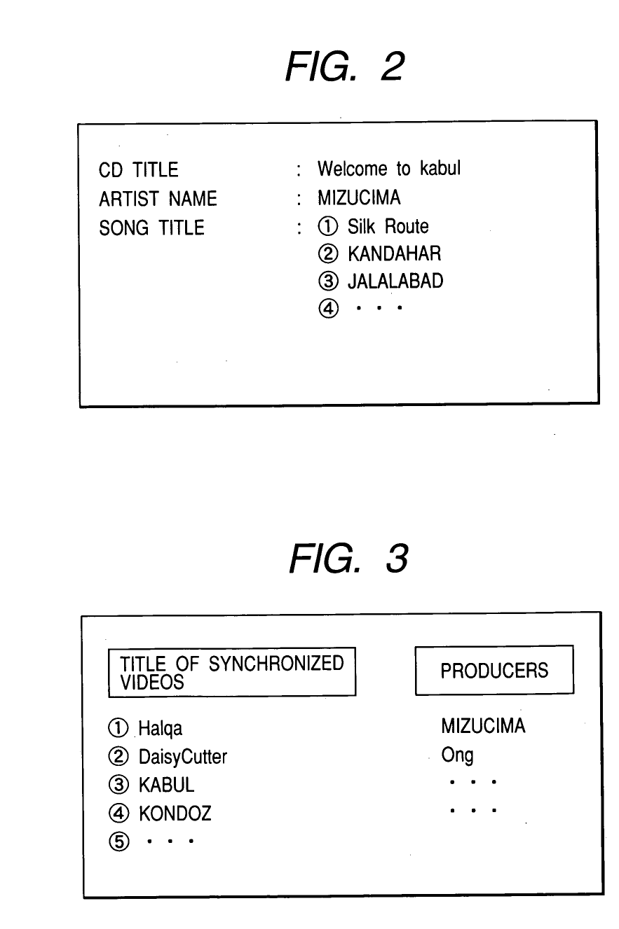

On the basis of the read information and the input information, the information analyzer 35 analyzes the nature of information which is to be transmitted from the server transmitter 36 to the terminal receiver 11. FIG. 2 shows an example at-a-glance list pertaining to music list information. The information analyzer 35 may prepare music list information in advance or after analysis, on the basis of information about a CD title, a song title, and the name of an artist associated with the music information or may prepare music list information on the basis of the read information and the input information. When an inserted CD is an extra CD, when the read information includes a CD title, a song title, and the name of an artist, and when the read information is information formed when the user inputs a CD title, a song title, and the name of an artist through use of the input terminal device 13 in letters and symbols, the information analyzer 35 checks the read information against the music information stored in the music information storage device 32, thereby analyzing whether or not the music information relates to the same CD title, song title, or artist's name. If the same CD title, song title, or artist's name is included in the music information, the music list information about the same CD title, song title, or artist's name is prepared. If the music information includes a plurality of the same CD titles, song names, or artist's names, the music list information about the same CD titles, song names, or artist's names is prepared. Further, if no match is found with the CD title, song name, or artist's name included in the music information, music list information indicating that no corresponding song is found is prepared. The thus-prepared music list information is transmitted to the server transmitter 36. In order to avoid occurrence of such complicated operation, the CD inserted into the CD drive 12 is preferably an extra CD in which information about a CD title, a song title, and the name of an artist are recorded. If corresponding music information is not found even when a match has occurred; if the read information states that the inserted CD is not an extra CD and reading of a CD title, a song title, and the name of an artists has failed; or if the user has not entered a CD title, a song title, and the name of an artist, the information analyzer 35 selects and transmits, to the server transmitter 36, music list information into which a plurality of CD titles, song titles, and artist's names stored in the music information storage device 32 are arranged in the Japanese KANA syllabary or music list information into which currently-popular songs are arranged in the manner of a list. As a result, the user can easily select information. The server transmitter 36 transmits the received music list information to the terminal receiver 11, as appropriate. When contents of the input information are limited to one or a plurality of specified music information items stored in the music information storage device 32, such as information indicating that the user has selected predetermined information from the list on the basis of the music list information displayed on the music information screen device 15, the information analyzer 35 prepares music list information associated with the corresponding music information, such as a CD title, a song title, and the name of an artist. The thus-prepared music list information is transmitted to the server transmitter 36. The synchronized video information storage device 33 selects synchronized video information associated with corresponding music information from the stored synchronized video information items.

FIG. 3 is an example list pertaining to the synchronized video list information. The information analyzer 35 prepares synchronized video list information into which video titles or names of tempo pertaining to one or a plurality of synchronized video information items are arranged. The information analyzer 35 may prepare synchronized video list information on the basis of, e.g., a video title or the name of tempo, attached to the synchronized video information or may prepare synchronized video list information on the basis of the input information. Alternatively, the information analyzer 35 checks the information into which the user has entered a video title or the name of tempo in letters or symbols through use of the terminal input device 13 against the synchronized video information stored in the synchronized video information storage device 33, thereby analyzing whether or not the synchronized video information relates to the same video title or the same name of tempo. If the same video title or the same name of tempo is available, synchronized video list information about the same video title or the same name of tempo is prepared. If a plurality of same video titles or a plurality of same names of tempo are available, synchronized video list information about the video titles or the names of tempo is prepared. Further, if the same video title or the same name of tempo is not available, there is prepared synchronized video list information indicating that no corresponding song is found. The information analyzer 35 transmits the music list information or the synchronized video list information to the server transmitter 36. The server transmitter 36 transmits the music list information or the synchronized video list information to the terminal receiver 11, as appropriate. When contents of the input information are limited to one or a plurality of specified music information items stored in the synchronized video information storage device 33, such as information indicating that the user has selected predetermined information from the list on the basis of the synchronized video list information displayed on the video information screen device 16, the information analyzer 35 selects corresponding synchronized video information from the synchronized video information storage device 33. Synchronized video list information about a video name and the name of tempo of the corresponding synchronized video information is prepared, and the synchronized video information and the synchronized video list information are transmitted to the server transmitter 36. The server transmitter 36 transmits the thus-received synchronized video information and the synchronized video list information to the terminal receiver 11. When the CD inserted into the CD drive 12 is an extra CD, the information analyzer 35 immediately selects specific music information from the read information and the input information, thereby preparing and selecting the music list information, the synchronized video list information, and the synchronized video information. The thus-prepared-and-selected information may be transmitted to the server transmitter 36. In this case, the user can view a specifically-synchronized video automatically by inserting the CD into the CD drive 12.

The information analyzer 35 transmits to the server transmitter 36 the relevant information stored in the relevant information storage device 34. The information analyzer 35 transmits, e.g., predetermined synchronized video information, to the server transmitter 36. After the display screen device 18 has displayed the predetermined video information, the information analyzer 35 transmits, e.g., artist list information, artist video information, and artist sound information, from among the relevant list information. Subsequently or prior to the artist list information, the information analyzer 35 may transmit, to the server transmitter 36, advertisement video information, advertisement sound information, and advertisement list information. When the user clicks, e.g., the changeover button device 17 after analysis of input information, to thereby view information about activities of an artist such as a singer, the information analyzer 35 transmits the artist list information to the server transmitter 36. Subsequently, the information analyzer 35 may analyze the information input by the use; select artist video information and artist sound information, both pertaining to an artist such as a specific singer, from the relevant information storage device 34; and transmit to the server transmitter 36. Further, the information analyzer 35 checks the input information into which the user has entered the name of an artist or an advertisement title in letters or symbols through use of the terminal input device 13 against the synchronized video information stored in the relevant information storage device 34, thereby analyzing whether or not the synchronized video information relates to the same name of an artist or the same advertisement title. If the same artist's name or the same advertisement title is available, the relevant list information about the same artist's name or the same advertisement title is prepared. If a plurality of same names of artists or a plurality of same titles of advertisements are available, the relevant list information about the artists' names or the names of advertisement are prepared. Further, if no match is found in the artist's name or the name of advertisement included in the information, relevant list information indicating that no corresponding information is found is selected and transmitted to the server transmitter 36. The information analyzer 35 may transmit the relevant video information and the relevant sound information to the server transmitter 36 along with the relevant list information. Through analysis of the information entered by the user after transmission of the relevant list information, artist video and sound information about an artist, such as a specific singer desired by the user, may be selected from the relevant information storage device 34, in which case the thus-selected information is transmitted to the server transmitter 36.

The server transmitter 36 receives the music list information, the synchronized video information, the synchronized video list information, and the relevant information, all being transmitted by the information analyzer 35, and transmits the information items to the terminal receiver 11, as appropriate. As mentioned previously, the server transmitter 36 transmits the music list information, the synchronized video information, the synchronized video list information, and the relevant information to the terminal receiver 11. Since the terminal 1 does not store the synchronized video information, the copyright on a video and music can be protected. The invention may be implemented by installing custom-designed software into the terminal 1, which may be a personal computer. Alternatively, custom-designed equipment, such as sound equipment, to be used for implementing the invention may be produced.

[First Embodiment]

Next, an invention of claim 2 will be described. The user connects the terminal 1 to the server 3 by way of the Internet. Information of large size is exchanged in the invention, and hence the terminal 1 and the server 3 are preferably connected together by means of broadband communication over the Internet. The user inserts a CD into the CD drive 12. When the invention is implemented through use of the custom-designed software installed in the terminal 1, the user may invoke the custom-designed software to be used for implementing the invention, or custom-designed software may be started automatically. The CD drive reads information about music recorded on the CD, and the thus-read information is transmitted to the synchronization analyzer 20 as CD information. When the CD inserted by the user is an extra CD and a CD title, a song title, and the name of an artist are recorded on the extra CD, the music information reader 14 reads the information about the CD title, the song title, and the name of an artist. The thus-read information is transmitted to the synchronization analyzer 20 as read information. When the CD is not an extra CD, the music information reader 14 transmits, to the synchronization analyzer 20, read information indicating that information about a CD title, a song title, and the name of an artist cannot be read. When the user has entered a CD title, a song title, and the name of an artist in letters and symbols through use of the terminal input device 13 or when the user has clicked the changeover button device 17, the terminal input device 13 transmits the information to the synchronization analyzer 20 as input information.

The synchronization analyzer 20 transmits the received read information and input information to the terminal transmitter 21. The terminal transmitter 21 transmits the thus-received read information and input information to the server receiver 31. The server receiver 31 transmits the thus-received read information and input information to the information analyzer 35. The information analyzer 35 analyzes contents of the read information. If the inserted CD is an extra CD and includes a CD title, a song title, and the name of an artist or if a CD title, a song title, and the name of an artist are available as a result of letters or symbols being input by the user, the read information is checked against the music information stored in the music information storage device 32. When the same music information is found, music list information is prepared from the corresponding one or a plurality of music information pieces. From among the synchronized video information items stored in the synchronized video information storage device 33, synchronized video information associated with the music information is selected. Synchronized video list information about the corresponding one or a plurality of corresponding synchronized video information items is prepared. The music list information and the synchronized video list information are transmitted to the server transmitter 36. When corresponding music information is not found through matching, when the contents of the read information indicate that the inserted CD is not an extra CD and reading of a CD title, a song title, and the name of an artist has failed, or when a CD title, a song title, or the name of an artist is determined to be unknown as a result of analysis of the contents of the input information, the information analyzer 35 selects music list information which is stored in the music information storage device 32 and into which a plurality of CD titles, a plurality of song titles, and names of artists are arranged in the form of a list in the order of the Japanese KANA syllabary or music list information into which currently popular numbers are arranged in the form of a list, thereby transmitting the selected information to the server transmitter 36.

The information analyzer 35 checks the information into which the user has entered a video title or the name of tempo in letters or symbols through use of the terminal input device 13 against the synchronized video information stored in the synchronized video information storage device 33, thereby analyzing whether or not the synchronized video information about the same video title or the same name of tempo is stored. If the same video title or the same name of tempo is stored, synchronized video list information about the same video title or the same name of tempo is prepared. If a plurality of the same video titles or a plurality of the same names of tempo are stored, synchronized video list information about the video titles or the names of tempo is prepared. Further, if the same video title or the same name of tempo is not stored, synchronized video list information indicating that no corresponding song is found is prepared. The information analyzer 35 transmits the music list information or the synchronized video list information to the server transmitter 36. The information analyzer 35 analyzes contents of the input information. For instance, if the user desires to view information about activities of an artist instead of a synchronized video, by clicking the changeover button device 17, the user can select artist list information of the relevant list information stored in the relevant information storage device 34, and the thus-selected information is transmitted to the server transmitter 36. The information analyzer 35 checks the information into which the user has entered the name of an artist or an advertisement title in letters or symbols through use of the terminal input device 13 against the synchronized video information stored in the relevant information storage device 34, thereby analyzing whether or not the synchronized video information relates to the same name of an artist or the same advertisement title. If the same artist's name or the same advertisement title is included, the relevant list information about the same artist's name or the same advertisement title is prepared. If a plurality of same names of artists or a plurality of same titles of advertisements are included in the synchronized video information, the relevant list information about the artists' names or the names of advertisement are prepared. Further, if no match is found in the artist's name or the name of advertisement, relevant list information indicating that no corresponding information is found is selected and transmitted to the server transmitter 36.

When the CD inserted into the CD drive 12 is an extra CD, the information analyzer 35 immediately selects specific music information from the read information and the input information, thereby preparing and selecting the music list information, the synchronized video list information, and the synchronized video information. The thus-prepared-and-selected information may be transmitted to the server transmitter 36. In this case, the user can view a specifically-synchronized video automatically by inserting the CD into the CD drive 12. Moreover, when the user can specify desired synchronized video information or relevant information by entering letters or symbols through use of the terminal input device 13, the information analyzer 35 may immediately select the specified synchronized video information, the relevant video information, the relevant sound information, and the relevant list information and transmit the information items to the server transmitter 36. In this case, the user can immediately view and listen to a desired video and information by specifying synchronized video information or relevant information for himself/herself. The server transmitter 36 receives the music list information, the synchronized video list information, the synchronized video information, and the relevant information and transmits the thus-received information items to the terminal receiver 11. The terminal receiver 11 receives the music list information, the synchronized video list information, the synchronized video information, and the relevant information and transmits the thus-received information items to the synchronization analyzer 20. The synchronization analyzer 20 receives the music list information, the synchronized video list information, the synchronized video information, and the relevant information, transmits the music list information to the music information screen device 15, and transmits the synchronized video list information and the relevant list information to the video information screen device 16. On the basis of the music list information, the music information screen device 16 receives the music list information and displays an at-a-glance list. The video information screen device 16 receives the synchronized video list information and the relevant list information, thereby displaying an at-a-glance list on the basis of the synchronized list information and the relevant list information. The synchronization analyzer 20 transmits the received synchronized video information to the display screen device 18 and transmits the received CD information to the performance device 19 such that a video display start time is synchronized with a music performance start time. Consequently, the user can view a video synchronized with music. The synchronization analyzer 20 transmits the received relevant video information to the display screen device 18 and transmits the received relevant sound information to the performance device 19 such that the video display start time is synchronized with a time at which playing and output of music and sound are to be started, whereby the user can view a video synchronized with music and sound. However, the synchronized video information—which has been selected by an information analyzer 35 from the information, such as a title of a video and the name of tempo, input by the user through use of the terminal input device 13 in characters or symbols—is not prepared in synchronism with the music recorded on the CD. Hence, music is not in step with the video. In this event, it may be the case that the synchronization analyzer 20 does not transmit CD information to the performance device 19, and the user enjoys only a video.

The user selects one or a plurality of specific information items from the at-a-glance list displayed on the music information screen device 15 and the video information screen device 16, through use of the terminal input device 13, or the user inputs a specific CD title, a specific song title, a specific artist's name, a specific video title, or a specific name of tempo through use of letters and symbols. The terminal input device 13 transmits the information entered by the user to the synchronization analyzer 20 as input information. The synchronization analyzer 20 transmits the received input information to the terminal transmitter 21, and the terminal transmitter 21 transmits the thus-received input information to the server receiver 31. The server receiver 31 transmits the thus-received input information to the information analyzer 35. The information analyzer 35 analyzes contents of the input information. If the information selected by the user corresponds to one specific music information item or a plurality of specific music information items, the information analyzer 35 prepares music list information on the basis of corresponding music information. The thus-prepared music list information is transmitted to the server transmitter 36. The information analyzer 35 analyzes contents of the input information. If the information selected by the user corresponds to one specific synchronized video information item or a plurality of specific synchronized video information items, corresponding synchronized video information is selected from the synchronized video information storage device 33. On the basis of the corresponding synchronized video information, synchronized video list information is prepared, and the synchronized video information and the synchronized video list information are transmitted to the server transmitter 36. If the information selected by the user does not correspond to one specific music information item or a plurality of specific music information items or if the information selected by the user does not correspond to one specific synchronized video information item or a plurality of specific synchronized video information items, the information analyzer 35 prepares music list information indicating that no corresponding song is available, or synchronized video list information indicating that no corresponding video is available. The thus-prepared list information is transmitted to the server transmitter 36, thereby again prompting the user to specify information.

The information analyzer 35 again analyzes contents of the received input information and checks the input information against the music information, the synchronized video information, and the relevant information, thereby specifying information desired by the user. When the information desired by the user cannot be specified, the information analyzer 35 again transmits the music list information, the synchronized video list information, and the relevant list information to the server transmitter 36, thereby again prompting the user to specify information. When the information desired by the user is specified, the information analyzer 35 prepares music list information; selects corresponding synchronized video information, relevant video information, relevant sound information, and relevant list information; prepares synchronized video list information; and transmits the information items to the server transmitter 36. The server transmitter 36 transmits the received information to the terminal receiver 11, and the terminal receiver 11 transmits the received information to the synchronization analyzer 20. The synchronization analyzer 20 transmits the received music list information to the music information screen device 15 and transmits the received synchronized video list information and the relevant list information to the video information screen device 16. The music information screen device 15 receives the music list information and displays an at-a-glance list on the basis of the music list information. The video information screen device 16 receives the synchronized video list information and the relevant list information, thereby displaying an at-a-glance list on the basis of the synchronized list information and the relevant list information. The synchronization analyzer 20 transmits the received synchronized video information to the display screen device 18 and transmits the received CD information to the performance device 19 such that a video display start time is synchronized with a music performance start time. Consequently, the user can view a video synchronized with music. The synchronization analyzer 20 transmits the received relevant video information to the display screen device 18 and transmits the received relevant sound information to the performance device 19 such that the video display start time is synchronized with a time at which playing and output of music and sound are to be started, whereby the user can view a video synchronized with music and sound. However, the synchronized video information—which has been selected by an information analyzer 35 from the information, such as a title of a video and the name of tempo, input by the user through use of the terminal input device 13 in characters or symbols—is not prepared in synchronism with the music recorded on the CD. Hence, music is not in step with the video. In this event, it may be the case that the synchronization analyzer 20 does not transmit CD information to the performance device 19, and the user enjoys only a video. In this way, the user can readily view a video synchronized with a purchased CD.

[Second Embodiment]

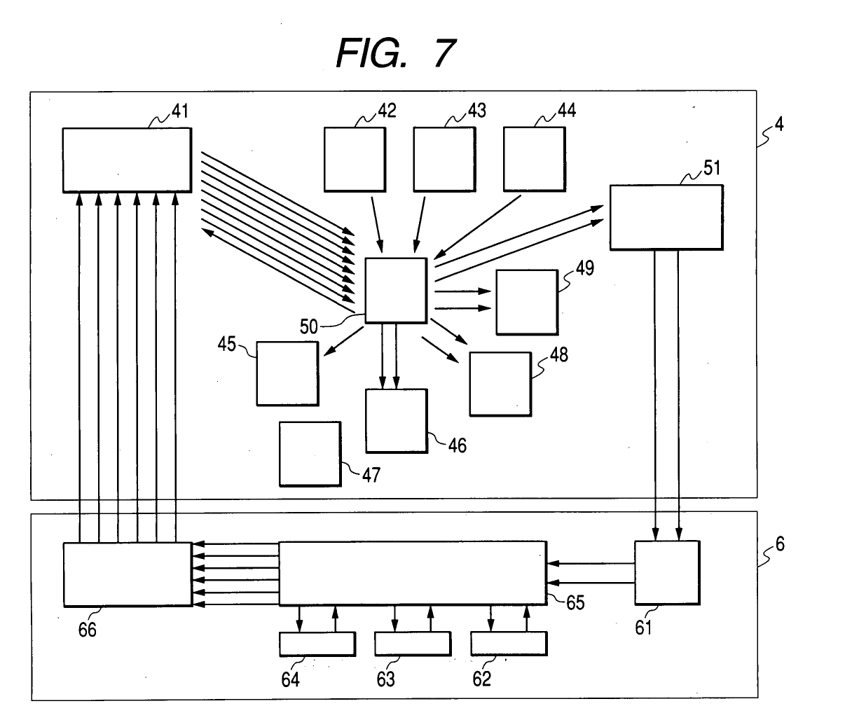

An invention of claim 3 will now be described. FIG. 7 is a block diagram of a system B. A terminal B4 comprises a terminal receiver B41; a CD drive B42; a terminal input device B43; a music information reader B44; a music information screen device B45; a video information screen device B46; an operation device 47; a display screen device B48; a performance device B49; a synchronization analyzer B50; and a terminal transmitter B51. A server B6 comprises a server receiver B61; a music information storage device B62; a synchronized video information storage device B63; a relevant information storage device B64; an information analyzer B65; and a server transmitter B66.

The terminal B4 may be a personal computer in which custom-designed software is installed and which can be connected to the Internet. Alternatively, the terminal may be sound equipment which displays, plays, and outputs a video, music, and sound over the Internet or a game machine, such as a PlayStation (Registered Trademark), which displays a video, plays music, and outputs sound. The custom-designed software is inserted into an extra CD as a program. When the extra CD is inserted into a CD drive of the personal computer, the personal computer may automatically install the custom-designed software. If the CD is not an extra CD, the user may install custom-designed software beforehand through use of distributed software or may download custom-designed software beforehand from a predetermined WEB page. One or a plurality of terminals B4 are connected to the server B6 by way of the Internet. In terms of the ability to transmit a large volume of synchronized video information at high speed, broadband communication capable of sending and receiving a large volume of information is preferable. The terminal receiver B41 is a device for receiving music list information, synchronized vide information, and synchronized video list information, all being sent by the server transmitter B66; for example, relevant video information, e.g., artist video information, advertisement video information, and offered video information; relevant sound information, e.g., artist sound information, advertisement sound information, and offered sound information; and relevant list information, e.g., artist list information, advertisement list information, and offered list information. The terminal receiver B41 does not store synchronized video information, and transmits received information to the synchronization analyzer B50. When having received the synchronized video information transmitted by the server B6, the terminal receiver B41 transmits a buffering start time as buffering start information and a buffering end time as buffering end information to the synchronization analyzer B50. Further, the terminal receiver B41 receives the in-process playback information transmitted by the synchronization analyzer B50 and performs buffering operation on the basis of the in-process playback information.

The CD drive B42 is a so-called CD drive for reading information pertaining to music recorded on a CD. A CD drive incorporated in a commercially-available personal computer or a CD drive incorporated into predetermined sound equipment or a game machine, which implement the invention, may also be used as the CD drive. The information—which is read by the CD drive B42 and pertains to music and sound—is transmitted to the synchronization analyzer B50 as CD information. The terminal input device B43 enables a user to input information, such as a CD title, a song title, and the name of an artist, in letters and symbols; to select desired information from an at-a-glance list displayed by the music information screen device B45 and the video information screen device B46; and to input a selection result or click a predetermined screen of the display screen device B48, thereby selecting information about, e.g., activities of an artist, information about an advertisement of an enterprise, or information offered by public organizations, and inputting a selection result. The terminal input device B43 is a device to be used for inputting an instruction, such as playback, pause, stop, in-process playback, selection forward, and selection backward of music to be played by use of the operation device 47, and may be embodied by a keyboard and a mouse. Even when the music information screen device B45 displays an at-a-glance list on the basis of music list information, the terminal input device B43 can delete them, to thereby enable input of a CD title, a song title, or the name of an artist in letters and symbols. Even when the video information screen device B46 displays an at-a-glance list on the basis of the synchronized video list information and the relevant list information, the terminal input device B43 can delete them, to thereby enable input of the title of a video in letters and symbols. The terminal input device B43 sends the information entered by the user to the synchronization analyzer B50 as input information B when the CD inserted into the CD drive B42 is an extra CD, the sound information reader B44 reads the title of the extra CD, a song title, and the name of an artist from the extra CD. When the inserted CD is not any extra CD, the music information reader B44 reads a CDID. The information read by the sound information reader B44 is transmitted to the synchronization analyzer B50 as the read information B.

The music information screen device B45 receives the music list information transmitted from the synchronization analyzer B50. On the basis of music list information, the music information screen device B45 displays a CD title, a song title, or the name of an artist; for example, only a song title; three information items, i.e., a CD title, a song title, and the name of an artist; or an at-a-glance list providing, e.g., the same song names or the same CD titles. The video information screen device B46 receives the synchronized video list information and the relevant list information sent from the synchronization analyzer B50. On the basis of the synchronized video list information, for example, the artist information, the video information screen device B46 displays an at-a-glance list which provides, e.g., only the video titles, or an at-a -glance list categorized into the video titles or the names of video producers. On the basis of the relevant list information, e.g., artist list information, the video information screen device B46 displays only the name of an artist or information items pertaining to activities released by the artist, in the form of an at-a-glance list and in ascending chronological order. For instance, when based on advertisement list information, the video information screen device B46 displays an at-a-glance list showing only names of enterprises which provide advertisement or enterprises to be advertised. When based on offered information, the video information screen device B46 displays an at-a-glance list of, e.g., information offered by public organizations.

The operation device 47 is a device for effecting playback, pause, stop, in-process playback, selection forward, and selection backward of music to be played and displays, e.g., a playback button, a stop button, and a pause button, on a predetermined location of the display screen device B48. The user selects any one button by clicking, e.g., the playback button, the stop button, and the pause button, through use of the terminal input device B43. The terminal input device B43 transmits a selection result to the synchronization analyzer B50 as input information B.

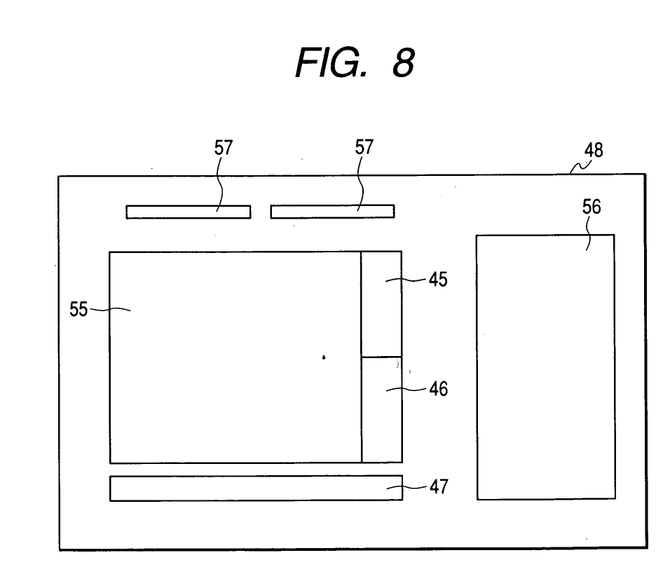

The display screen device B48 is a device for receiving and displaying the synchronized video information and the relevant video information transmitted from the synchronization analyzer B50. FIG. 8 is an example of the display screen device B48. The display screen device B48 may be divided into a main screen 55 for displaying, e.g., a synchronized video on the basis of synchronized video information; a sub-screen 56 for displaying a recent activity status of an artist from among the relevant video information or a screen of another WEB page; and a small screen 57 for providing an advertisement or information which is as small as a banner advertisement or the like. The display screen device B48 preferably displays in a separated manner the synchronized video information on the main screen 55, and relevant video information on the sub-screen 56 or the small screen 57. The performance device B49 is a device for receiving CD information transmitted from the synchronization analyzer B50 and playing and outputting music and sound on the basis of the CD information.

The synchronization analyzer B50 brings a video into synchronism with music and analyzes the kind of a video, music, and sound to be played and output. The synchronization analyzer B50 receives the music list information, synchronized video information, synchronized video list information, and relevant information, all being transmitted by the terminal receiver B41; the CD information transmitted from the CD drive B42; input information B transmitted from the terminal input device B43; and read information B transmitted from the music information reader B44. The synchronization analyzer B50 transmits the received read information B and the received input information B to the terminal transmitter B51; transmits the music list information to the music information screen device B45; transmits the synchronized video list information and the relevant list information to the video information screen device B46; transmits the synchronized video information and the relevant video information to the display screen device B48; and transmits the CD information and the relevant sound information to the performance device B49.

The synchronization analyzer B50 specifies, at the head, a playback position for the CD information. Simultaneously with having received buffering start information transmitted by the terminal receiver B41, the synchronization analyzer B50 requests a pause such that received synchronized video information is not transmitted to the display screen device B48. The synchronization analyzer B50 receives buffering end information and synchronized video information; resets a pause for the synchronized video information such that the synchronized video information is synchronized with the CD information; transmits the synchronized video information to the display screen device B48; and transmits the CD information to the performance device B48. Consequently, the display screen device B48 and the performance device B49 synchronously display and play a video, music, and sound.

When the user has selected desired music from the music information screen device B45 and a desired video from the video information screen device B46 through use of the terminal input device B43, the terminal input device B43 transmits the input information B to the synchronization analyzer B50; the synchronization analyzer B50 transmits the input information B to the terminal transmitter B51; the terminal transmitter B51 transmits the input information B to the server B6; and the synchronization analyzer 50 extracts the synchronized video information synchronized with desired music and desired synchronized video information from the server B6.

When the user has selected a pause button of the operation device 47 by clicking the button through use of the terminal input device B43, the terminal input device B43 transmits the input information B to the synchronization analyzer B50. The synchronization analyzer B50 receives the input information B and requests a pause for transmission of the synchronized video information and the CD information in a synchronized manner, thereby effecting pausing operation. When the user has selected a pause cancel button, the synchronization analyzer 50 cancels a pause for transmission of the synchronized video information and the CD information in a synchronized manner.

The synchronization analyzer 50 computes a time required to effect buffering, from buffering start information and buffering end information. The thus-computed time required for buffering is taken as expected buffering information. The time required to effect buffering is dependent on the level of traffic over the Internet at different times and hence is unstable. For this reason, a time at which buffering would surely be completed is set, and the thus-set time is added to the expected buffering information. Thus, a time at which buffering would surely be completed is taken as buffering information. Tests conducted by the inventor show that adding four to six seconds to the expected buffering information is desirable, to thereby create buffering information. For example, when the user has used the operation device 47 to select in-process playback which is to be started three minutes later from the start of predetermined music on a CD, the terminal input device B43 transmits the input information B to the synchronization analyzer B50. The synchronization analyzer B50 receives the input information B. After three minutes have lapsed since predetermined music was started, a pause for transmission of CD information is requested. The synchronization analyzer B50 requests a pause for a synchronized video after three minutes have lapsed since predetermined music was started. The synchronization analyzer B50 transmits in-process playback information to the terminal input device B43 such that buffering is started at a time induced by subtracting a time-which is determined as a result of lapse of three minutes since the predetermined music for which the pause has been requested was started-from the time based on the buffering information. On the basis of the in-process playback information, the terminal input device B43 performs buffering operation and sends synchronized video information to the synchronization analyzer B50. The synchronization analyzer B50 cancels a pause for transmission of the synchronized video information and the CD information after lapse of three minutes since predetermined music was started. Buffering has already been completed by the buffering information after three minutes have lapsed since the predetermined music was started, and hence a synchronized video, music, and sound are synchronized with each other.

The terminal transmitter B51 is a device for transmitting, to the server receiver B61, the read information B and the input information B, both being transmitted by the synchronization analyzer B50. The server transmitter B66 transmits the music list information, the synchronized video information, the synchronized video list information, the relevant video information, the relevant sound information, and the relevant list information. The terminal B4 does not store the synchronized video information. Consequently, the copyright on a video synchronized with music, that on a video pertaining to activities of an artist such as a singer, and that on sound can be protected.

The server receiver B61 is a device for receiving the read information B and the input information B, both being transmitted from the terminal transmitter B51, and transmitting the thus-received information to the information analyzer B65. The music information storage device B62 is a device which stores music information and music list information and enables deletion and alteration of music information of the past and music list information of the past and addition of new music information. The music information pertains to a CD title, a song title, and the name of an artist with regard to the music released by an artist, such as a singer, in the past. The music information is given a designation and can be checked against the CDID. In addition to the above-described elements, the music information may pertain to, e.g., the tempo, length, and genre of a song. The music information is also associated with the synchronized video information regarding a synchronized video prepared so as to be synchronized with a CD song related to the music information. The music list information stored in the music information storage device B62 is music list information into which a plurality of CD titles, a plurality of song titles, and names of artists are arranged in the form of a list in the order of the Japanese KANA syllabary, or music list information into which currently popular numbers are arranged in the form of a list. The synchronized video information storage device B63 is a device for storing synchronized video information and the synchronized video list information and enables deletion or alteration of synchronized video information of the past and addition of new synchronized video information. The synchronized video information is prepared such that the synchronized video information becomes synchronous with the song of a predetermined CD, by making a play start time of a song of the CD concurrent with a display start time of a synchronized video. Further, a large number of videos prepared by a VJ, such as those which can be seen in a club or a disco club, performance of a symphony, a video of a RAKUGO storyteller, and a video of KABUKI, are stored, thereby providing the user with a highly-elaborate, high-quality video. Moreover, appropriate deletion or addition of video information enables provision of ever-attractive videos to the user. For instance, a designation, such as a video title or the name of tempo, is added to synchronized video information. The synchronized video information includes information synchronized with sound other than a song of a CD, such as ROKYOKU or RAKUGO, so long as the information is synchronized with a song of the CD. The synchronized video list information is information into which video information is arranged in the form of a list on the basis of, e.g., a CD title.

The relevant information storage device B64 stores relevant information and enables deletion or alteration of relevant information of the past and addition of new relevant information. FIG. 4 shows an example at-a-glance list pertaining to artist list information; FIG. 5 shows an example list pertaining to advertisement list information; and FIG. 6 shows an example list pertaining to offered list information. The relevant information is formed from relevant video information, relevant sound information, and relevant list information, and respective relevant information pieces are assigned designations in association with the synchronized video information, the synchronized video list information, the music information, and the music list information. The relevant information is prepared in compliance with and associated with specifications of the sub-screen 56 and the small screen 57 of the display screen device B48. The relevant video information and the relevant list information may be, e.g., a WEB page or a banner advertisement. The user may cause a jump to another WEB page by use of the terminal input device B43. Such relevant information items include, e.g., artist video information pertaining to activities of an artist, e.g., a singer; artist sound information pertaining to sound to be added to the artist video information; advertisement video information pertaining to advertisements of enterprises to be advertised; advertisement sound information to be added to the advertisement video information; offered video information pertaining to information offered to other users by other organizations such as public organizations; offered sound information pertaining to sound to be added to the offered video information; artist list information pertaining to a list of stored information items; advertisement list information; and offered list information. The relevant information is not fixed to these categories. For instance, artist video information is described specifically. Information which an artist desires to report by himself/herself is taken as artist video information, and sound to be added to the video is synchronized with the video, to thereby prepare artist sound information. Artist list information is prepared, in which information is arranged in the sequence of information items released in the past or according to categories to which information pertains. The artist list information is stored in the relevant information storage device B64. For instance, the advertisement video information will be described specifically. There is prepared advertisement video information showing an artist, such as a singer, who is taken as advertising means by an enterprise. Advertisement sound information is prepared such that sound to be added to the video is synchronized with the video. Advertisement list information is prepared, in which information is arranged in the form of a list in the sequence of advertisements released in the past or according to products which are objects of the advertisements. The advertisement list information is stored in the relevant information storage device B64. For instance, the offered video information will now be described specifically. News and information which the public organization desires to report to the user are visualized, to thereby prepare offered video information. Offered sound information is prepared by bringing sound to be added to a video in synchronism with the video. A Offered list information is prepared, in which information is arranged in the form of a list in the sequence of news and information of the past or according to categories of news and information. The offered list information is stored in the relevant information storage device B64. The respective relevant information items can be deleted or added appropriately, thereby enabling provision of ever-attractive relevant information to the user. Information can be limited to only relevant video information, without the addition of relevant video information. Conversely, information can be limited to only relevant sound information without the addition of relevant video information. The relevant list information makes it easy for the user to select desired information from enormous amounts of information, thus providing the user with convenience.

The information analyzer B65 is a device which receives the read information B and the input information B, all being output from the server receiver 61, and which analyzes the nature of information to be transmitted to the server transmitter B66, on the basis of the read information B and the input information B. FIG. 2 shows an example at-a-glance list pertaining to music list information. The information analyzer B65 can prepare music list information on the basis of information about a CD title, a song title, and the name of an artist, all being associated with predetermined music information and synchronized video information. FIG. 3 is an example of an at-a-glance list pertaining to synchronized video list information. The information analyzer B65 can prepare synchronized video list information into which video titles and the names of tempo pertaining to one or a plurality of synchronized video information items are arranged in the form of a list. When an inserted CD is an extra CD, the information analyzer B65 analyzes a CD title, a song title, and the name of an artist on the basis of the read information B. The information analyzer B65 checks the CD title, the song title, and the name of an artist against the synchronized video information stored in the synchronized video information storage device B63. Associated predetermined synchronized video information, the synchronized video list information, and the music list information are selected from the synchronized video information storage device B63 and the music information storage device B62. Portions of the synchronized video list information and the music list information are prepared. The thus-selected information and the thus-prepared information are transmitted to the server transmitter B66. In this way, when an extra CD is used, the synchronized video information or the like can be transmitted efficiently. When the inserted CD is not an extra CD, the information analyzer B65 analyzes the CDID on the basis of the read information B; checks the CDID against the music information stored in the music information storage device B62; selects the predetermined synchronized video information and the synchronized video list information, both being associated with the music information, from the synchronized video information storage device B63 and the music information storage device B62; prepares portions of the synchronized video list information and the music list information; and transmits the thus-prepared information to the server transmitter B66. On the basis of the input information B, the user selects desired music and synchronized video information associated with a synchronized video synchronized video from the music information screen device B45 and the video information screen device B46, and synchronized video list information and music list information from the synchronized video information storage device B63 and the music information storage device B62, through use of the terminal input device B43; and the information analyzer B65 prepares portions of the synchronized video list information and the music list information and transmits the thus-prepared information to the server transmitter B66. When the user has selected a CD title, a song title, and the name of an artist in letters and symbols on the basis of the input information B, the information analyzer B65 checks the thus-selected information against the music information stored in the music information storage device B62 and the synchronized video information stored in the synchronized video information storage device B63; selects the predetermined synchronized video information, the synchronized video list information, and the music list information from the synchronized video information storage device B63 and the music information storage device B62; prepares portions of the synchronized video list information and the music list information; and transmits the thus-prepared information to the server transmitter B66. When the synchronized video desired by the user is not available, the information analyzer B65 prepares music list information and synchronized video list information, both stating that no corresponding music or video is available. The thus-prepared list information is transmitted to the server transmitter B66. Even in this case, predetermined relevant information may be selected and transmitted to the server transmitter B66. In order to avoid occurrence of such complication operation, the CD inserted into the CD drive B42 is preferably an extra CD in which information about a CD title, a song title, and the name of an artist are recorded. If corresponding music information is not found even when a match has occurred, music list information into which a plurality of CD titles, song titles, and artist's names stored in the music information storage device B62 are arranged in the Japanese KANA syllabary or music list information into which currently-popular songs are arranged in the manner of a list is selected and transmitted to the server transmitter B66. As a result, the user can easily select information.

The information analyzer B65 transmits the relevant information stored in the relevant information storage device B64 to the server transmitter B66. The information analyzer B65 selects the selected synchronized video information, the music information, the synchronized video list information, and the relevant information associated with the music list information and transmits the thus-selected information to the server transmitter B66. When the name of information about the associated artist or advertisement is available, the information analyzer B65 selects relevant list information pertaining to information about that artist or advertisement. When a relevant video is available, the associated video information is selected. When associated music and sound are available, relevant sound information is selected. The thus-selected information is transmitted to the server transmitter B66. If no relevant artist or advertisement is available, relevant list information indicating that no corresponding information is available is selected. The relevant information may be transmitted to the server transmitter B66.

The server transmitter B66 is a device for receiving the music list information, the synchronized video information, the synchronized video list information, and the relevant information, all being transmitted by the information analyzer B65, and transmitting the information items to the terminal receiver B41, as appropriate. As mentioned previously, the server transmitter B66 transmits the music list information, the synchronized video information, the synchronized video list information, and the relevant information to the terminal receiver B41. Since the terminal B4 does not store the synchronized video information, the copyright on a video and music can be protected.

[Fourth Embodiment]

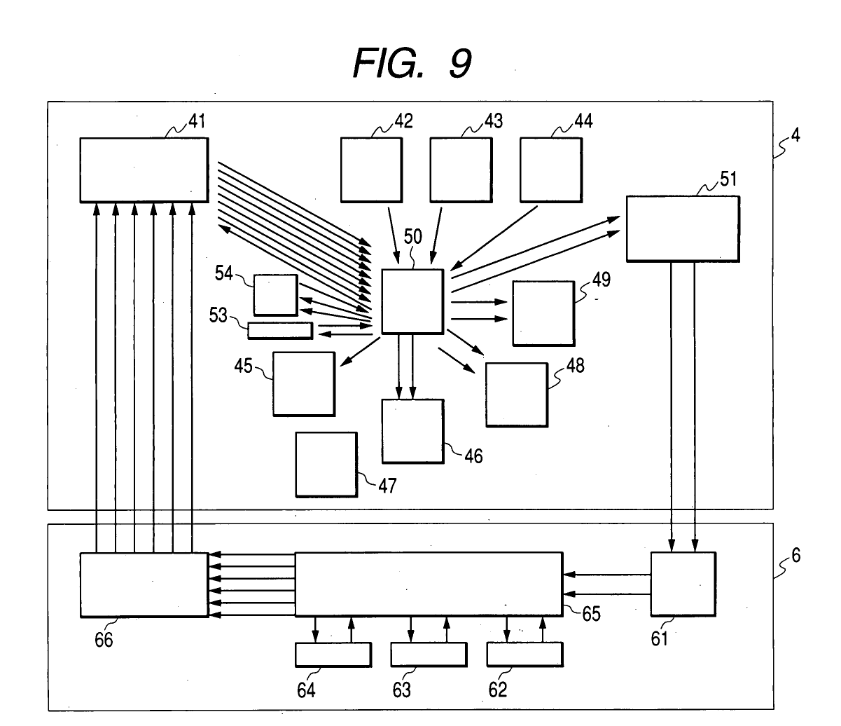

An invention of claim 4 will now be described. FIG. 9 is a block diagram of a system C. A terminal C7 comprises a terminal receiver C41; a CD drive B42; a terminal input device B43; a music information reader B44; a music information screen device B45; a video information screen device B46; an operation device 47; a display screen device B48; a performance device B49; a synchronization analyzer C52; a terminal transmitter B51; a CD storage device 53; and a stability determination device 54.

The terminal C7 may be a personal computer in which custom-designed software is installed and which can be connected to the Internet. Alternatively, the terminal may be sound equipment which displays, plays, and outputs a video, music, and sound over the Internet, or a game machine, such as a PlayStation (Registered Trademark), which displays a video, plays music, and outputs sound. The custom-designed software is inserted into an extra CD as a program. When the extra CD is inserted into a CD drive of the personal computer, the personal computer may automatically install the custom-designed software. If the CD is not an extra CD, the user may install custom-designed software beforehand through use of distributed software or may download custom-designed software beforehand from a predetermined WEB page. One or a plurality of terminals C7 are connected to the server B6 by way of the Internet. In view of the ability to transmit a large volume of synchronized video information at high speed, broadband communication capable of sending and receiving a large volume of information is preferable. The CD information storage device 53 is a device into which the synchronization analyzer C52 stores CD information.

In addition to performing the functions of the synchronization analyzer B50, the synchronization analyzer C52 can store CD information into the CD information storage device 53 and extract CD information from the CD information storage device 53. In synchronism with transmission of synchronized video information to the display screen device B48, the synchronization analyzer C52 extracts CD information stored in the CD information storage device and transmits the thus-extracted information to the performance device B49. In this way, the synchronization analyzer C52 can achieve synchronization by either of two methods: that is, a method for achieving synchronization by issuing a pause for transmission of the synchronized video information to the display screen device B48, and a method for achieving synchronization by storing CD information into the CD information storage device 53 and extracting the CD information from the CD information storage device. Variations arise in the speed at which the CD drive 42 reads the CD information, because of circumstances of an electrical system. Hence, either one of the two methods enables realization of stability with enhanced accuracy. In the case of the method in which synchronization is achieved by issuing a pause for transmission of synchronized video information to the display screen device B48, the synchronization analyzer C52 measures a time lag between the synchronized video and music. The time lag is sent to the stability determination device 54 as time lag information A. In the case of the method in which synchronization is achieved by storing CD information in the CD information storage device 53 and extracting the CD information from the CD information storage device 53, a time lag between a synchronized video and music is measured and the time lag is sent to the stability determination device 54 as time lag information B. The synchronization analyzer C52 receives the stability information from the stability determination device 54 and analyzes contents of the stability information. When contents of the stability information indicate selection of a method for achieving synchronization by issuing a pause for transmission of the synchronized video information to the display screen device B48, the synchronization analyzer C52 brings the synchronized video in synchronism with music by the method. Conversely, when contents of the stability information indicate selection of a method for achieving synchronization by storing CD information into the CD information storage device 53 and extracting the CD information from the CD information storage device 53, the synchronization analyzer C52 brings the synchronized video in synchronism with music by the method. Moreover, the synchronized video can be brought in step with music by combination of a method for achieving synchronization by issuing a pause for transmission of synchronized video information to the display screen device B48, such as extraction of CD information from the CD information storage device 53 when a pause for transmission of the synchronized video information to the display screen device B48 is canceled and transmission of the CD information to the performance device B49 in synchronism with cancellation of the pause; and a method for achieving synchronization by extracting the CD information from the CD information storage device 53.

The stability determination device 54 is a determination device which determines that higher stability is achieved by adoption of the method for achieving synchronization by issuing a pause for transmission of synchronized video information to the display screen device B48 or adoption of the method for achieving synchronization by storing CD information into the CD information storage device 53 and extracting the CD information from the CD information storage device 53. The stability determination device 54 receives the time lag information A and the time lag information B, both being transmitted from the synchronization analyzer C52. The stability determination device 54 analyzes contents of the time lag information A and those of the time lag information B, thereby determining time lag information having a smaller value. For instance, when the time lag information A has a smaller value than that of the time lag information B, there is prepared stability information indicating selection of a method for achieving synchronization by issuing a pause for transmission of synchronized video information to the display screen device B48. In contrast, when the time lag information B has a value smaller than that of the time lag information A, there is prepared stability information indicating selection of a method for storing CD information into the CD information storage device 563 and extracting the CD information from the CD information storage device 53. The thus-prepared stability information is transmitted to the synchronization analyzer C52. Functions and explanations of other devices of the fourth embodiment are the same as those described in connection with the third embodiment in which the synchronization analyzer B is replaced with the synchronization analyzer C.

[Fifth Embodiment]

An invention of claim 5 will now be described. The user connects the terminal device B4 to the server B6 by way of the Internet. In the invention, information of large size is exchanged, and hence broadband communication over the Internet is preferable. Preferably, the user installs custom-designed software into a personal computer through use of distributed software, or downloads custom-designed software from a predetermined WEB site. When an extra CD is used, a program of custom-designed software is inserted into the extra CD. After the extra CD has been inserted into the personal computer, the custom-designed software may start automatically. Alternatively, the user may also use sound equipment or a game machine, which implements the invention. The user inserts a CD into the CD drive B42. The CD drive B42 sends information about the read music and sound to the synchronization analyzer B50. When the CD inserted into the CD drive B42 is an extra CD, the music information reader B44 reads a CD title, a song title, and the name of an artist from the extra CD. When the CD is not an extra CD, the music information reader B44 reads a CDID, and the read information is transmitted to the synchronization analyzer B50 as read information B. When the user has entered a CD title, a song title, and the name of an artist in letters and symbols, the terminal input device B43 transits the result of selection performed by the user to the synchronization analyzer B50 as input information B. Even when merely a CD is inserted into the CD drive, the music information reader B44 automatically reads information or a CDID on the extra CD and transmits the thus-read information or the CDID to the synchronization analyzer B50. Hence, the user can perform easy operation.

The synchronization analyzer B50 transmits the received read information B and the received input information B to the terminal transmitter B51. The terminal transmitter B51 transmits the thus-received read information B and input information B to the server receiver B61. The server receiver B61 transmits the thus-received read information B and the input information B to the information analyzer B65. The information analyzer B65 analyzes contents of the read information B. When the inserted CD is an extra CD and has a CD title, a song title, and the name of an artist, the information analyzer 65 checks the thus-selected information against the music information stored in the synchronized video information storage device B63; selects the predetermined synchronized video information, the synchronized video list information, and the music list information from the synchronized video information storage device B63 and the music information storage device B62; prepares portions of the synchronized video list information and the music list information; and transmits the thus-prepared information to the server transmitter B66. Thus, when the extra CD is used, the synchronized video information or the like can be transmitted efficiently. When the inserted CD is not an extra CD, the information analyzer 65 analyzes the CDID from the read information B; checks the thus-selected information against the music information stored in the music information storage device B62; selects the predetermined synchronized video information, the synchronized video list information, and the music list information, all being associated with the music information, from the synchronized video information storage device B63 and the music information storage device B62; prepares portions of the synchronized video list information and the music list information; and transmits the thus-prepared information to the server transmitter B66. Thus, when the extra CD is used, the synchronized video information or the like can be transmitted efficiently. When the user has selected a CD title, a song title, or the name of an artist in letters and symbols on the basis of the input information B, the information analyzer B65 checks the thus-selected information against the music information stored in the music information storage device B62 and the synchronized video information stored in the synchronized video information storage device B63; selects the predetermined synchronized video information, the synchronized video list information, and the music list information from the synchronized video information storage device B63 and the music information storage device B62; prepares portions of the synchronized video list information and the music list information; and transmits the thus-prepared information to the server transmitter B66. When the synchronized video desired by the user is not available, the information analyzer B65 prepares music list information and synchronized video list information, both stating that no corresponding music or video is available. The thus-prepared list information is transmitted to the server transmitter B66. Even in this case, predetermined relevant information may be selected and transmitted to the server transmitter B66. In order to avoid occurrence of such complication operation, the CD inserted into the CD drive B42 is preferably an extra CD in which information about a CD title, a song title, and the name of an artist are recorded. If corresponding music information is not found even when a match has arisen, the information analyzer B65 may select music list information into which a plurality of CD titles, song titles, and artist's names stored in the music information storage device B62 are arranged in the Japanese KANA syllabary or music list information into which currently-popular songs are arranged like a list and may transmit the thus-selected information to the server transmitter B66. As a result, the user can easily select information.

The information analyzer B65 selects relevant information which is associated with predetermined synchronized video information, the synchronized video list information, the music information, and the music list information. The thus-selected relevant information is sent to the server transmitter B66. When relevant information about activities of a predetermined artist is available, artist video information and artist sound information are transmitted. For instance, when relevant information relating to a predetermined advertisement is available, advertisement video information is transmitted. The server transmitter B66 receives the music list information, the synchronized video list information, the synchronized video information, and the relevant information and transmits the thus-received information to the terminal receiver B41.

The terminal receiver B41 receives the music list information, the synchronized video list information, the synchronized video information, and the relevant information and sends the music list information, the synchronized video list information, and the relevant information to the synchronization analyzer B50. The terminal receiver B41 transmits the buffering start time as buffering start information and a buffering end time as buffering end information to the synchronization analyzer B50. The synchronization analyzer B50 receives the music list information, the synchronized video list information, the relevant information, and the CD information. The synchronization analyzer B50 specifies, at the head, a playback position for the CD information. Simultaneously with having received buffering start information transmitted by the terminal receiver B41, the synchronization analyzer B50 requests a pause such that received synchronized video information is not transmitted to the display screen device B48. The synchronization analyzer B50 receives the buffering end information and the synchronized video information; resets a pause for the synchronized video information such that the synchronized video information is synchronized with the CD information; transmits the synchronized video information to the display screen device B48; and transmits the CD information to the performance device B49. Consequently, the display screen device B49 and the performance B49 synchronously display and play a video, music, and sound. The synchronization analyzer B50 transmits the music list information to the music information screen device B45 and the synchronized video list information and the relevant list information to the video information screen device B46. The music information screen device B45 receives the music list information and displays an at-a-glance list based on the music list information. The video information screen device B46 receives the synchronized video list information and the relevant list information and displays an at-a-glance list which is based on the synchronized list information and the relevant list information. Further, the synchronization analyzer B50 transmits the thus-received relevant video information to the display screen device B48 and the received relevant sound information to the performance device B49. As a result, the user can view information about activities of an artist and information, a video of an artist, an advertisement, information released by the public organization, or the like. Even after completion of the music and sound desired by the user, a video pertaining to activities of an artist, an advertisement video, or advertisement sound may be displayed on, played by, and output by the display screen device B48 and the performance device B49.

When the user has selected desired music from the music information screen device B45 and a desired video from the video information screen device B46 through use of the terminal input device B43, the terminal input device B43 transmits the result of selection performed by the user as the input information B to the synchronization analyzer B50. The synchronization analyzer B50 transmits the input information B to the terminal transmitter B51. The terminal transmitter B51 transmits the input information B to the server receiver B61. The server receiver B61 transmits the received input information B to the information analyzer B65. When the user has selected synchronized video information associated with desired music and a desired video from the music information screen device B45 and the video information screen device B46, synchronized video list information from the synchronized video information storage device B63, and the music list information from the music information storage device B62, through use of the terminal input device B43, the information analyzer B65 prepares portions of the synchronization video list information and the music list information. The thus-prepared information is transmitted to the server transmitter B66. Further, the information analyzer B65 selects relevant information which is associated with the predetermined synchronized video information, the synchronized video list information, the music information, and the music list information, and the thus-selected information is transmitted to the server transmitter B66. The server transmitter B66 receives the music list information, the synchronized video list information, the synchronized video information, and the relevant information and transmits the thus-received information to the terminal receiver B41.

The terminal receiver B41 receives the music list information, the synchronized video list information, the synchronized video information, and the relevant information and sends the music list information, the synchronized video list information, and the relevant information to the synchronization analyzer B50. The terminal receiver B41 transmits the buffering start time as buffering start information and a buffering end time as buffering end information to the synchronization analyzer B50. The synchronization analyzer B50 receives the music list information, the synchronized video list information, the relevant information, and the CD information. The synchronization analyzer B50 specifies, at the head, a playback position for the CD information. Simultaneously with having received buffering start information transmitted by the terminal receiver B41, the synchronization analyzer B50 requests a pause for transmission of synchronized video information. The synchronization analyzer B50 receives the buffering end information and the synchronized video information; resets a pause for the synchronized video information such that the synchronized video information is synchronized with the CD information; transmits the synchronized video information to the display screen device B48; and transmits the CD information to the performance device B49. Consequently, the display screen device B49 and the performance B49 synchronously display and play a video, music, and sound. The synchronization analyzer B50 transmits the music list information to the music information screen device B45 and the synchronized video list information and the relevant list information to the video information screen device B46. The music information screen device B45 receives the music list information and displays an at-a-glance list based on the music list information. The video information screen device B46 receives the synchronized video list information and the relevant list information and displays an at-a-glance list which is based on the synchronized list information and the relevant list information. Further, the synchronization analyzer B50 transmits the thus-received relevant video information to the display screen device B48 and the received relevant sound information to the performance device B49. As a result, the user can view information about activities of an artist and information, a video of an artist, an advertisement, information released by the public organization, or the like. Even after completion of the music and sound desired by the user, a video pertaining to activities of an artist, an advertisement video, or advertisement sound may be displayed on, played by, and output by the display screen device B48 and the performance device B49.

When the user desires to temporarily stop music and a synchronized video, the user selects a pause button of the operation device 47 by clicking the button through use of the terminal input device B43. The terminal input device B43 transmits, to the synchronization analyzer B50, a result of selection performed by the user as the input information B. The synchronization analyzer B50 receives the input information B and requests a pause for transmission of the synchronized video information and the CD information in a synchronized manner, thereby performing pause operation. When the user has selected a pause cancel button by means of clicking the button through use of the terminal input device B43, the terminal input device B43 transmits a result of selection performed by the user to the synchronization analyzer B50 as the input information B. The synchronization analyzer B50 analyzes the input information B and cancels the pause for transmission of the synchronized video information and the CD information in a synchronized manner.

There will now be described a case where the user desires in-process playback of predetermined music of a CD after three minutes have lapsed since the music was started. The synchronization analyzer B50 computes a time required to effect buffering from buffering start information and buffering end information. The thus-computed time required for buffering is taken as expected buffering information. The time required to effect buffering is dependent on the level of traffic over the Internet at different times and hence unstable. For this reason, a time at which buffering would surely be completed is set, and the thus-set time is added to the expected buffering information. Thus, a time at which buffering would surely be completed is taken as buffering information. Tests conducted by the inventor show that adding four to six seconds to the expected buffering information is desirable, to thereby create buffering information. The user specifies a time after three minutes since the predetermined music is started, through use of the terminal input device B43. The terminal input device B43 takes a result of specification performed by the user as the input information B and transmits the input information B to the synchronization analyzer B50. The synchronization analyzer B50 receives the input information B and requests a pause for transmission of CD information after three minutes have lapsed since predetermined music was started. The synchronization analyzer B50 transmits in-process playback information to the terminal input device B43 such that buffering is started at a time induced by subtracting a time—which is determined as a result of lapse of three minutes since the predetermined music for which the pause has been requested was started—from the time based on the buffering information. On the basis of the in-process playback information, the terminal input device B43 performs buffering operation and sends synchronized video information to the synchronization analyzer B50. The synchronization analyzer B50 cancels a pause for transmission of the synchronized video information and the CD information after lapse of three minutes since predetermined music was started. Buffering has already been completed by the buffering information after three minutes have lapsed since the predetermined music was started, and hence a synchronized video, music, and sound are synchronized with each other. Even during the course of in-process playback operation, the user can enjoy a video, music, and sound, all being synchronized with each other.

The user can also enjoy information and sound pertaining to activities of an artist displayed on the sub-screen 56 on the basis of the relevant information while enjoying a synchronized video on the main screen 55 of the display screen device B48. When a WEB page and a banner advertisement are displayed on the sub-screen 56 of the display screen device B48, a jump to another WEB page or the like can be readily performed by clicking the display screen device B48 through use of the terminal input device B43, thus yielding great convenience.

[Sixth Embodiment]

An invention of claim 6 will now be described. The terminal C7 is connected to the server B6, and the CD drive B42 reads information from an inserted CD. These operations are the same as those in the case of the fifth embodiment in which the synchronization analyzer B is replaced with the synchronization analyzer C. Here, a method differing from that adopted in the fifth embodiment will now be described. The synchronization analyzer C52 stores CD information into the CD information storage device 53. In synchronism with transmission of the synchronized video information to the display screen device B48, the CD information is extracted from the CD information storage device 53, and the thus-extracted CD information is transmitted to the performance device B49. In this way, the synchronization analyzer C52 can achieve synchronization by either of two methods: that is, a method for achieving synchronization by issuing a pause for transmission of the synchronized video information to the display screen device B48, and a method for achieving synchronization by storing CD information into the CD information storage device 53 and extracting the CD information from the CD information storage device. Variations arise in the speed at which the CD drive 42 reads the CD information, because of circumstances of an electrical system. Hence, either of the two methods enables realization of stability with enhanced accuracy. In the case of the method in which synchronization is achieved by issuing a pause for transmission of synchronized video information to the display screen device B48, the synchronization analyzer C52 measures a time lag between the synchronized video and music. The time lag is sent to the stability determination device 54 as time lag information A. In the case of the method in which synchronization is achieved by storing CD information in the CD information storage device 53 and extracting the CD information from the CD information storage device 53, a time lag between a synchronized video and music is measured and the time lag is sent to the stability determination device 54 as time lag information B.

The stability determination device 54 receives the time lag information A and the time lag information B, both being transmitted from the synchronization analyzer C52. The stability determination device 54 analyzes contents of the time lag information A and those of the time lag information B, thereby determining time lag information having a smaller value. For instance, when the time lag information A has a smaller value than that of the time lag information B, there is prepared stability information indicating selection of a method for achieving synchronization by issuing a pause for transmission of synchronized video information to the display screen device B48. In contrast, when the time lag information B has a value smaller than that of the time lag information A, there is prepared stability information indicating selection of a method for storing CD information into the CD information storage device 53 and extracting the CD information from the CD information storage device 53. The thus-prepared stability information is transmitted to the synchronization analyzer C52. The synchronization analyzer C52 receives the stability information from the stability determination device 54 and analyzes contents of the stability information. When contents of the stability information indicate selection of a method for achieving synchronization by issuing a pause for transmission of the synchronized video information to the display screen device B48, the synchronization analyzer C52 brings the synchronized video in synchronism with music by the method. Conversely, when contents of the stability information indicate selection of a method for achieving synchronization by storing CD information into the CD information storage device 53 and extracting the CD information from the CD information storage device 53, the synchronization analyzer C52 brings the synchronized video in synchronism with music by the method. Moreover, the synchronization analyzer C52 can bring the synchronized video in step with music by combination of a method for achieving synchronization by issuing a pause for transmission of synchronized video information to the display screen device B48, such as extraction of CD information from the CD information storage device 53 when a pause for transmission of the synchronized video information to the display screen device B48 is canceled and transmission of the CD information to the performance device B49 in synchronism with cancellation of the pause; and a method for achieving synchronization by extracting the CD information from the CD information storage device 53.

An advantage of the invention is to enable the user to view a highly-elaborate video synchronized with music and sound of a purchased CD and to provide the user with an everlasting-attractive video by alteration or addition of a video, thereby enabling the user to easily utilize a video again and again. The user can perform in-process playback or pause of a video and music, which are synchronized with each other. Further, in addition to a synchronized video, the user can readily select information about activities of an artist, an advertisement of an enterprise, and information offered by the public organization, thus yielding great convenience. An artist, such as a singer, can also efficiently report personal information to his/her fans. As a result of the user who has purchased a CD viewing a synchronized video again and again, opportunities where the user views an advertisement are increased, and hence the enterprise can efficiently provide an advertisement. The invention can also protect the copyright on music and that on a video synchronized with the music.

What is claimed is:

1. A video, music, and sound information distribution system for distributing by utilization of the Internet a video synchronized with music and sound, comprising:
a terminal including
a terminal receiver which receives music list information, synchronized video information, synchronized video list information, relevant video information, relevant sound information, and relevant list information and which transmits, to a synchronization analyzer, the music list information, the synchronized video information, the synchronized video list information, the relevant video information, the relevant sound information, and the relevant list information;
a CD drive for transmitting CD information to the synchronization analyzer;
a terminal input device for transmitting input information to the synchronization analyzer;
a music information reader for transmitting read information to the synchronization analyzer;
a music information screen device for receiving music list information;
a video information screen device for receiving the synchronized video list information and the relevant list information;
a changeover button device;
a display screen device for receiving the synchronized video information and the relevant video information;
a performance device for receiving the CD information and the relevant sound information;
a synchronization analyzer which receives the music list information, the synchronized video information, the synchronized video list information, the relevant video information, the relevant sound information, the relevant list information, and the CD information and which transmits the music list information to the music information screen device, transmits the synchronized video list information and the relevant list information to the video information screen device, transmits the synchronized video information and the relevant video information to the display screen device, transmits the CD information and the relevant sound information to the performance device, and transmits the read information and the input information to a terminal transmitter; and
a terminal transmitter which receives the read information and the input information and transmits the read information and the input information to the server receiver; and
a server including
a server receiver which receives the read information and the input information and transmits the read information and the input information to an information analyzer;
a music information storage device which stores the music information and the music list information;
a synchronized video information storage device for storing the synchronized video information;
a relevant information storage device for storing the relevant video information, the relevant sound information, and the relevant list information;
an information analyzer which receives the read information and the input information and which transmits, to a server transmitter, the music list information, the synchronized video information, the synchronized video list information, the relevant video information, the relevant sound information, and the relevant list information; and
a server transmitter which receives the music list information, the synchronized video information, the synchronized video list information, the relevant video information, the relevant sound information, and the relevant list information and which transmits, to the terminal receiver, the music list information, the synchronized video information, the synchronized video list information, the relevant video information, the relevant sound information, and the relevant list information, wherein
one or a plurality of terminals are connected to the server by utilization of the Internet.

2. A video, music, and sound information distribution method for distributing a video synchronized with music and sound through use of a system which utilizes the Internet, the system comprising:
a terminal including
a terminal receiver which receives music list information, synchronized video information, synchronized video list information, relevant video information, relevant sound information, and relevant list information and which transmits, to a synchronization analyzer, the music list information, the synchronized video information, the synchronized video list information, the relevant video information, the relevant sound information, and the relevant list information;
a CD drive for transmitting CD information to the synchronization analyzer;
a terminal input device for transmitting input information to the synchronization analyzer;
a music information reader for transmitting read information to the synchronization analyzer;
a music information screen device for receiving music list information;
a video information screen device for receiving the synchronized video list information and the relevant list information;
a changeover button device;
a display screen device for receiving the synchronized video information and the relevant video information;
a performance device for receiving the CD information and the relevant sound information;
a synchronization analyzer which receives the music list information, the synchronized video information, the synchronized video list information, the relevant video information, the relevant sound information, the relevant list information, and the CD information and which transmits the music list information to the music information screen device, transmits the synchronized video list information and the relevant list information to the video information screen device, transmits the synchronized video information and the relevant video information to the display screen device, transmits the CD information and the relevant sound information to the performance device, and transmits the read information and the input information to a terminal transmitter; and
a terminal transmitter which receives the read information and the input information and transmits the read information and the input information to the server receiver; and
a server including
a server receiver which receives the read information and the input information and transmits the read information and the input information to an information analyzer;
a music information storage device which stores the music information and the music list information;
a synchronized video information storage device for storing the synchronized video information;
a relevant information storage device for storing the relevant video information, the relevant sound information, and the relevant list information;
an information analyzer which receives the read information and the input information and which transmits, to a server transmitter, the music list information, the synchronized video information, the synchronized video list information, the relevant video information, the relevant sound information, and the relevant list information; and
a server transmitter which receives the music list information, the synchronized video information, the synchronized video list information, the relevant video information, the relevant sound information, and the relevant list information and which transmits to the terminal receiver the music list information, the synchronized video information, the synchronized video list information, the relevant video information, the relevant sound information, and the relevant list information, wherein
one or a plurality of terminals are connected to the server by utilization of the Internet.

3. A video, music, and sound information distribution system for distributing a video synchronized with music and sound by utilization of the Internet, comprising:
a terminal B including
a terminal receiver B which receives music list information, synchronized video information, synchronized video list information, relevant video information, relevant sound information, relevant list information, and in-process playback information and which transmits, to a synchronization analyzer B, the music list information, the synchronized video information, the synchronized video list information, the relevant video information, the relevant sound information, the relevant list information, buffering start information, and buffering end information;
a CD drive B for transmitting CD information to the synchronization analyzer B;
a terminal input device B for transmitting input information B to the synchronization analyzer B;
a music information reader B for transmitting read information B to the synchronization analyzer B;
a music information screen device B for receiving the music list information;
a video information screen device B for receiving the synchronized video list information and the relevant list information;
an operation device;
a display screen device B for receiving the synchronized video information and the relevant video information;
a performance device B for receiving the CD information and the relevant sound information;
a synchronization analyzer B which receives the music list information, the synchronized video information, the synchronized video list information, the relevant video information, the relevant sound information, the relevant list information, the CD information, the buffering start information, and the buffering end information and which transmits the music list information to the music information screen device B, transmits the synchronized video list information and the relevant list information to the video information screen device B, transmits the synchronized video information and the relevant video information to the display screen device B, transmits the CD information and the relevant sound information to the performance device B, transmits the in-process playback information to the terminal receiver B, and transmits the read information B and the input information B to the terminal transmitter B; and
a terminal transmitter B which receives the read information B and the input information B and transmits the read information B and input information B to the server receiver B; and
a server B including
a server receiver B which receives the read information B and the input information B and transmits the read information B and the input information B to the information analyzer B;
a music information storage device B which stores the music information and the music list information;
a synchronized video information storage device B for storing the synchronized video information;
a relevant information storage device B for storing the relevant video information, the relevant sound information, and the relevant list information;
an information analyzer B which receives the read information B and the input information B and which transmits, to a server transmitter B, the music list information, the synchronized video information, the synchronized video list information, the relevant video information, the relevant sound information, and the relevant list information; and
a server transmitter B which receives the music list information, the synchronized video information, the synchronized video list information, the relevant video information, the relevant sound information, and the relevant list information and which transmits, to the terminal receiver B, the music list information, the synchronized video information, the synchronized video list information, the relevant video information, the relevant sound information, and the relevant list information, wherein
one or a plurality of terminals B are connected to the server B by utilization of the Internet.

4. A video, music, and sound information distribution system for distributing a video synchronized with music and sound by utilization of the Internet, comprising:
a terminal C including
a terminal receiver B which receives music list information, synchronized video information, synchronized video list information, relevant video information, relevant sound information, relevant list information, and in-process playback information and which transmits, to a synchronization analyzer C, the music list information, the synchronized video information, the synchronized video list information, the relevant video information, the relevant sound information, the relevant list information, buffering start information, and buffering end information;
a CD drive B for transmitting CD information to the synchronization analyzer C;
a terminal input device B for transmitting input information B to the synchronization analyzer C;
a music information reader B for transmitting read information B to the synchronization analyzer C;
a music information screen device B for receiving the music list information;
a video information screen device B for receiving the synchronized video list information and the relevant list information;
an operation device;
a display screen device B for receiving the synchronized video information and the relevant video information;
a performance device B for receiving the CD information and the relevant sound information;
a synchronization analyzer C which receives the music list information, the synchronized video information, the synchronized video list information, the relevant video information, the relevant sound information, the relevant list information, the CD information, the buffering start information, the buffering end information, and stable information and which transmits the music list information to the music information screen device B, transmits the synchronized video list information and the relevant list information to the video information screen device B, transmits the synchronized video information and the relevant video information to the display screen device B, transmits the CD information and the relevant sound information to the performance device B, transmits the in-process playback information to the terminal receiver B, transmits time lag information A and time lag information B to a stability determination device, transmits the read information B and the input information B to the terminal transmitter B, stores CD information into a CD information storage device, and extracts the CD information from the CD information storage device;
a CD information storage device for storing CD information;
a stability determination device which receives the time lag information A and the time lag information B and transmits stable information to the synchronization analyzer C;
a terminal transmitter B which receives the read information B and the input information B and transmits the read information B and input information B to the server receiver B; and
a server B including
a server receiver B which receives the read information B and the input information B and transmits the read information B and the input information B to the information analyzer B;
a music information storage device B which stores the music information and the music list information;
a synchronized video information storage device B for storing the synchronized video information;
a relevant information storage device B for storing the relevant video information, the relevant sound information, and the relevant list information;
an information analyzer B which receives the read information B and the input information B and which transmits, to a server transmitter B, the music list information, the synchronized video information, the synchronized video list information, the relevant video information, the relevant sound information, and the relevant list information; and
a server transmitter B which receives the music list information, the synchronized video information, the synchronized video list information, the relevant video information, the relevant sound information, and the relevant list information and which transmits, to the terminal receiver B, the music list information, the synchronized video information, the synchronized video list information, the relevant video information, the relevant sound information, and the relevant list information, wherein
one or a plurality of terminals C are connected to the server B by utilization of the Internet.

5. A video, music, and sound information distribution method for use with a system which distributes a video synchronized with music and sound by utilization of the Internet, the system comprising:
a terminal B including
a terminal receiver B which receives music list information, synchronized video information, synchronized video list information, relevant video information, relevant sound information, relevant list information, and in-process playback information and which transmits to a synchronization analyzer B the music list information, the synchronized video information, the synchronized video list information, the relevant video information, the relevant sound information, the relevant list information, buffering start information, and buffering end information;
a CD drive B for transmitting CD information to the synchronization analyzer B;
a terminal input device B for transmitting input information B to the synchronization analyzer B;
a music information reader B for transmitting read information B to the synchronization analyzer B;
a music information screen device B for receiving the music list information;
a video information screen device B for receiving the synchronized video list information and the relevant list information;
an operation device;
a display screen device B for receiving the synchronized video information and the relevant video information;
a performance device B for receiving the CD information and the relevant video information;
a synchronization analyzer B which receives the music list information, the synchronized video information, the synchronized video list information, the relevant video information, the relevant sound information, the relevant list information, the CD information, the buffering start information, and the buffering end information and which transmits the music list information to the music information screen device B, transmits the synchronized video list information and the relevant list information to the video information screen device B, transmits the synchronized video information and the relevant video information to the display screen device B, transmits the CD information and the relevant sound information to the performance device B, transmits the in-process playback information to the terminal receiver B, and transmits the read information B and the input information B to the terminal transmitter B; and
a terminal transmitter B which receives the read information B and the input information B and transmits the read information B and input information B to the server receiver B; and
a server B including
a server receiver B which receives the read information B and the input information B and transmits the read information B and the input information B to the information analyzer B;
a music information storage device B which stores the music information and the music list information;
a synchronized video information storage device B for storing the synchronized video information;
a relevant information storage device B for storing the relevant video information, the relevant sound information, and the relevant list information;
an information analyzer B which receives the read information B and the input information B and which transmits to a server transmitter B the music list information, the synchronized video information, the synchronized video list information, the relevant video information, the relevant sound information, and the relevant list information; and
a server transmitter B which receives the music list information, the synchronized video information, the synchronized video list information, the relevant video information, the relevant sound information, and the relevant list information and which transmits to the terminal receiver B the music list information, the synchronized video information, the synchronized video list information, the relevant video information, the relevant sound information, and the relevant list information, wherein
one or a plurality of terminals B are connected to the server B by utilization of the Internet.

6. A video, music, and sound information distribution method for use with a system which distributes a video synchronized with music and sound by utilization of the Internet, the system comprising:
a terminal C including
a terminal receiver B which receives music list information, synchronized video information, synchronized video list information, relevant video information, relevant sound information, relevant list information, and in-process playback information and which transmits to a synchronization analyzer C the music list information, the synchronized video information, the synchronized video list information, the relevant video information, the relevant sound information, the relevant list information, buffering start information, and buffering end information;
a CD drive B for transmitting CD information to the synchronization analyzer C;
a terminal input device B for transmitting input information B to the synchronization analyzer C;
a music information reader B for transmitting read information B to the synchronization analyzer C;
a music information screen device B for receiving the music list information;
a video information screen device B for receiving the synchronized video list information and the relevant list information;
an operation device;
a display screen device B for receiving the synchronized video information and the relevant video information;
a performance device B for receiving the CD information and the relevant sound information;
a synchronization analyzer C which receives the music list information, the synchronized video information, the synchronized video list information, the relevant video information, the relevant sound information, the relevant list information, the CD information, the buffering start information, the buffering end information, and stable information and which transmits the music list information to the music information screen device B, transmits the synchronized video list information and the relevant list information to the video information screen device B, transmits the synchronized video information and the relevant video information to the display screen device B, transmits the CD information and the relevant sound information to the performance device B, transmits the in-process playback information to the terminal receiver B, transmits time lag information A and time lag information B to a stability determination device, transmits the read information B and the input information B to the terminal transmitter B, stores CD information into a CD information storage device, and extracts the CD information from the CD information storage device;
a CD information storage device for storing CD information;
a stability determination device which receives the time lag information A and the time lag information B and transmits stable information to the synchronization analyzer C;
a terminal transmitter B which receives the read information B and the input information B and transmits the read information B and input information B to the server receiver B; and
a server B including
a server receiver B which receives the read information B and the input information B and transmits the read information B and the input information B to the information analyzer B;
a music information storage device B which stores the music information and the music list information;
a synchronized video information storage device B for storing the synchronized video information;
a relevant information storage device B for storing the relevant video information, the relevant sound information, and the relevant list information;
an information analyzer B which receives the read information B and the input information B and which transmits, to a server transmitter B, the music list information, the synchronized video information, the synchronized video list information, the relevant video information, the relevant sound information, and the relevant list information; and
a server transmitter B which receives the music list information, the synchronized video information, the synchronized video list information, the relevant video information, the relevant sound information, and the relevant list information and which transmits to the terminal receiver B the music list information, the synchronized video information, the synchronized video list information, the relevant video information, the relevant sound information, and the relevant list information, wherein
one or a plurality of terminals C are connected to the server B by utilization of the Internet.
